(19) United States
(12) Patent Application Publication
(10) Pub. No.: US 2006/0240850 A1
(43) Pub. Date: Oct. 26, 2006

(54) Method and system for sending binary messages

(76) Inventor: Diego Kaplan, San Diego, CA (US)

Correspondence Address: KYOCERA WIRELESS CORP., P.O. BOX 928289, SAN DIEGO, CA, 92192-8289, US

(21) Appl. No.: 11/112,035

(22) Filed: Apr. 22, 2005

(51) Int. Cl. H04Q 7/20

(52) U.S. Cl. 455/466

(57) ABSTRACT

Systems and methods for sending binary messages to a wireless communication device are provided. A mobile handset maintains a database of contacts including an indicator identifying whether a particular contact is capable or incapable of receiving a binary message. When a mobile handset attempts to send a binary message to a recipient, the contact database is consulted to determine if the status of the recipient's capability for receiving and correctly processing the binary message. If the recipient status is capable, the binary message is sent. If the recipient status is incapable, the user is prompted for instructions. A user may elect to send the binary message anyway, send a text only part of the message, or cancel sending the binary message altogether. If the recipient's status is unknown, the mobile handset sends a special message to the recipient that will prompt a response from the recipient if it is capable of processing a binary message. Based on the receipt or lack of receipt of a response, the database is updated accordingly and the mobile handset either sends the binary message or prompts the user for instructions on how to proceed.

### BACKGROUND

1. Field of the Invention

The present invention generally relates to wireless communications and more particularly relates to sending binary short message system messages, enhanced message system messages, and multimedia message system messages to a wireless communication device.

2. Related Art

Short Message Service (“SMS”) is a text message service that enables short messages of generally no more than 140-160 characters in length to be sent to and transmitted from a mobile handset. SMS was initially introduced in the global system for mobile communications (“GSM”) network system and later became supported by all other digital-based mobile communications systems. Unlike paging, but similar to e-mail, SMS messages are managed by an SMS server so that a mobile handset can retrieve a message later if it was not available to receive the message when it was sent. SMS messages travel to the mobile handset over the network system's control channel, which is separate and apart from the voice channel.

Conventional SMS message implementations on mobile handsets are limited to sending and receiving text messages. This limitation prevents the distribution of binary messages that may include, e.g., an executable program, an image, an audio clip, a video clip, or some combination of these. While some implementations of SMS allow the sending of encrypted messages, these encrypted messages are still limited to text.

The enhanced message system (“EMS”) is an extension of SMS that provides a limited capability to send and receive binary objects to and from EMS capable handsets. A significant drawback of EMS messaging is that if an EMS message is sent to a handset that is not EMS capable any binary objects that are part of that message will not be received. EMS is considered to be an intermediate technology between SMS and the multimedia message system (“MMS”), with more capabilities than SMS, but fewer than MMS. MMS is also an extension to SMS and provides the capability to exchange binary messages between MMS enabled handsets.

As mobile handset devices become more commonplace and their computing resources such as volatile and persistent memory, processor capability, etc., increase, the industry will demand systems and methods that overcome the limitations in the conventional systems described above.

### SUMMARY

Accordingly, to meet the expected demands of the industry and consumers, systems and methods for providing binary messages to a wireless communication device are disclosed herein. A mobile handset maintains in its database of contacts an indicator identifying whether a particular contact is capable or incapable of receiving a binary message. The indicator may be very granular and define a variety of binary message capabilities for the particular contact so that standard and non-standard binary communications may be exchanged without taxing the network bandwidth with binary messages that are incapable of being received.

When a user of the mobile handset attempts to send a binary message to a recipient, the contact database is consulted to determine if the recipient is capable of receiving and correctly processing the message, incapable, or if the recipient's ability is unknown. If the recipient is capable, the binary message is sent. If the recipient is identified as incapable of receiving the binary message, the user is prompted for instructions. A user may elect to send the binary message anyway to test the recipient's current capability, send a text only part of the message, or cancel sending the binary message altogether. If the ability of the recipient is unknown, the mobile handset sends a special message to. the recipient that will prompt a response from the recipient if it is capable of processing a binary message. If the mobile handset receives a positive response, then the database is updated accordingly and the mobile handset sends the binary message. If the mobile handset does not receive a positive response, then the database is updated accordingly and the user is prompted for instruction on how to proceed.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example system according to an embodiment of the present invention;

FIG. 2A is a block diagram illustrating an example data storage area according to an embodiment of the present invention;

FIG. 2B is a block diagram illustrating an example contact record in a data storage area according to an embodiment of the present invention;

FIG. 3 is a block diagram illustrating an example wireless communication device according to an embodiment of the present invention;

FIG. 4 is a flow diagram illustrating an example process for sending binary SMS messages according to an embodiment of the present invention;

FIG. 5 is a flow diagram illustrating an example process for determining the capability of a recipient device to receive a binary message according to an embodiment of the present invention;

FIG. 6 is a flow diagram illustrating an example process for determining if a recipient entry has timed out according to an embodiment of the present invention;

FIG. 7 is a block diagram illustrating an exemplary wireless communication device that may be used in connection with the various embodiments described herein; and

FIG. 8 is a block diagram illustrating an exemplary computer system as may be used in connection with various embodiments described herein.

### DETAILED DESCRIPTION

Disclosed herein are systems and methods that allow a wireless communication device to send binary messages to recipient wireless communication devices. For example, one method described herein allows for a wireless communication device to maintain a database of recipient devices that includes the ability of the recipient device to receive binary messages or portions thereof. The wireless communication device determines the recipient's capability prior to sending the binary message and if necessary prompts the user for instructions on how to proceed with respect to sending a partial binary message.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

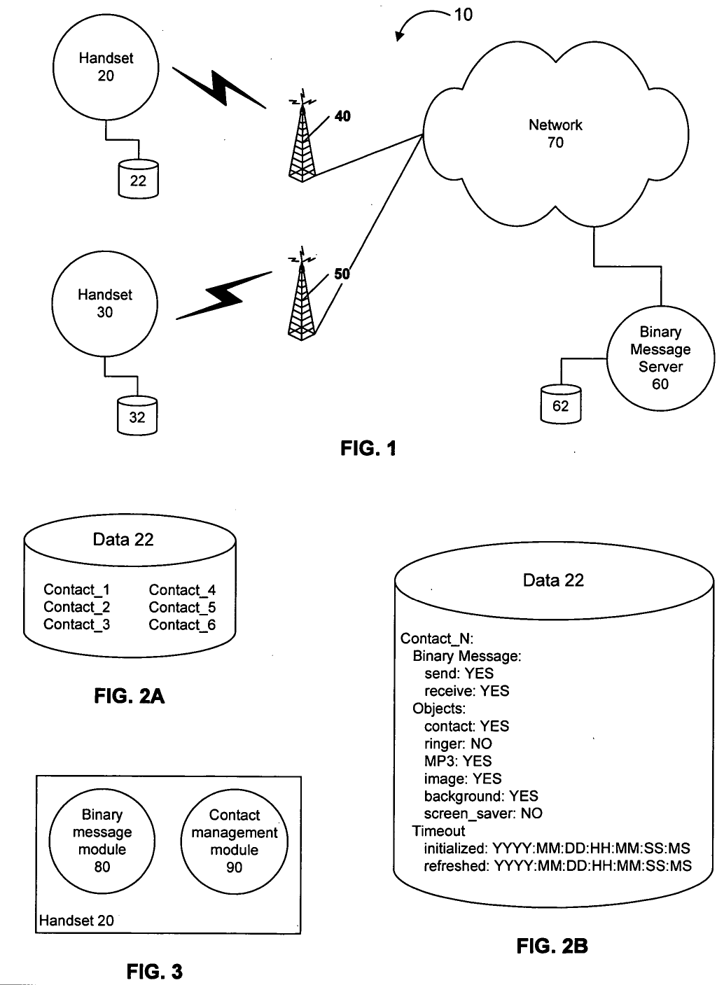

FIG. 1 is a high level network diagram illustrating an example system 10 for sending binary messages according to an embodiment of the present invention. Throughout this description a binary message may be a binary SMS message, binary EMS message, binary MMS message, or a binary message conforming to an alternative protocol. In the illustrated embodiment, the system comprises a plurality of wireless communication devices such as handsets 20 and 30. Handsets 20 and 30 are each coupled with a data storage area, respectively data storage areas 22 and 32. The handsets 20 and 30 are also communicatively coupled with a binary message server 60 via a network 70 comprising one or more base stations such as base stations 40 and 50. The binary message server 60 can be considered to be part of the network 70. Although not illustrated for the sake of simplicity, there can be many more handsets than the number illustrated, many more base stations than the number illustrated, and many more binary message servers than the number illustrated.

The handset 20 can be any type of device capable of wireless communication with network 70. For example, handset 20 may be an analog or digital cell phone, a personal digital assistant (“PDA”), a personal computer (“PC”), laptop computer, tablet computer, or other type of device with the ability to communicate over network 70. In one embodiment, handset 20 is capable of both voice calls (circuit switched) and data calls (packet switched). Additionally, handset 20 may advantageously be configured for simultaneous voice and data calls as well as being capable to send and receive binary messages.

Throughout this description the handset 20 will be discussed in the context of an analog or digital cell phone, although it is to be understood that any type of wireless communication device may be used in place of an analog or digital cell phone. Handset 20 may be alternatively referred to herein as a mobile handset, a wireless communication device, a wireless device, a handset, or a wireless handset.

The handset 20 is coupled with a data storage area 22. The data storage area 22 can integrated in the body of the handset 20 or be configured as a removable storage unit. The data storage area 22 can be implemented as a persistent memory device or a volatile memory device. For example, data storage area 22 can be a read only memory (“ROM”) random access memory (“RAM”), flash memory, programmable ROM, or conventional hard drive, just to name a few. The physical medium employed as data storage area 22 can employ various types of data storage organization means such as a file system structure, database structure, or the like.

Data storage area 22 can preferably be used to store executable programs, audio files, graphic image files, text files, audio-video files, and other types of data and information. For example, the operating system of the handset 20 can be stored in data storage area 22. Other examples of programs, files, and information that can be housed in data storage area 22 include custom ring audio files, display background image files, contact information files, digital image files, digital audio files, digital video and audio files, and other multi-media types of files, just to name a few. Other types of files, data, and information can also be stored in data storage area 22, as will be understood by one having skill in the art.

Network 70 may encompass a number of base stations such as base stations 40 and 50. The network 70 can be managed by a wireless communication service provider (i.e., access provider) such as Sprint, Verizon, AT&T Wireless, and T-Mobile, just to name a few. In the illustrated embodiment, binary message server 60 is part of the network 70. The binary message server 60 is configured with a data storage area 62 and performs the function of managing binary message communications over the network 70. For example, the binary message server 60 may manage SMS, EMS, and MMS messages as well as binary and text messages employing alternative protocols.

Furthermore, network 70 can advantageously be a public or private circuit switched or packet switched network. Network 70 can be a personal area network (“PAN”) a local area network (“LAN”), a wide area network (“WAN”), or some combination of networks such as the network ubiquitously known as the Internet. In the illustrated embodiment, handset 20 can send, and receive binary messages with any computing device capable of communication over the network 70. In one embodiment, network 70 can act as a bridge network between the handsets 20 and 30 and a packet switched data network, such as a private LAN or a public network such as the Internet (both not shown). Such a bridge function may facilitate binary messages between the handsets 20 and 30 and binary message capable devices on other networks.

FIG. 2A is a block diagram illustrating an example data storage area 22 according to an embodiment of the present invention. In the illustrated embodiment, the data storage area 22 is shown having a plurality of records for contacts 1-6. The data storage area 22 is adaptable for storage of any number of contact records, limited only by the physical size of the data storage area 22. As previously described, the data storage area 22 can be an integrated storage unit, an external storage unit, or a removable storage unit. In one embodiment, data storage area 22 can be any combination of integrated, external, or removable storage units to effectively allow an open ended upper limit to the size of the data storage area 22.

In an alternative embodiment, the contact records may be the same records that are maintained by the phone book of the handset 20. Typically, wireless communication devices have a phone book or contact list feature that maintains information for various contacts. The illustrated contact records may be those very same contacts in an embodiment that is tightly integrated with the creator of module or modules that maintain the phone book on the handset 20. Alternatively, the contact records stored in data storage area 22 may be maintained separately from the phone book on the handset. In such an embodiment, the contact records can be compressed or otherwise manipulated so that the amount of storage in bytes is minimized for each contact record.

FIG. 2B is a block diagram illustrating an example record for contact_N in a data storage area 22 according to an embodiment of the present invention. In the illustrated embodiment, the record for contact_N is shown with a set of attributes that are maintained as part of the record. In alternative embodiments, the set of attributes may include additional attributes and may exclude certain illustrated attributes. In one embodiment, a user can select what attributes to maintain in a contact record, for example, the user may desire that timeout information not be maintained.

In the illustrated embodiment, the contact record comprises a list of capabilities for a particular contact. The contact record maintains information regarding the ability of the particular contact to send and receive binary messages. The contact record maintains information regarding the ability of the particular contact to receive specific types of binary objects. For example, types of binary objects may include a contact record, a ringer, an MP3 audio clip, an image, a background graphic, and a screen saver, just to name a few. The capability of the particular contact to receive other types of binary objects may also be maintained in the contact record, without limitation on the type of binary objects.

In addition to the capabilities of the particular contact that may be maintained in the contact record, certain system management information may also be maintained. For example, in the illustrated embodiment timeout information is maintained for a particular contact. The timeout information may be used to periodically purge records from the data storage area 22 so that the aggregate storage area consumed by the contact records is kept to a minimum. In one embodiment, the timeout information includes a timestamp identifying when the record was initialized and a timestamp identifying when the record was most recently refreshed. Thus, a global timeout value may be set that purges records even if the contact record was recently refreshed. This provides the ability to minimize the amount of information exchanged during a refresh operation. In such an embodiment, after a record is purged, the next time the contact is sent a binary message, the entire contact record is re-initialized, thereby updating all information pertaining to the contact record.

FIG. 3 is a block diagram illustrating example modules of a handset 20 according to an embodiment of the present invention. In the illustrated embodiment, the handset 20 comprises a binary message module 80 and a contact management module 90. The binary message module 80 is configured to manage binary message communications. The binary message module 80 is configured to send binary message communications to recipient devices and is also configured to receive binary message communications and respond to binary message capability queries.

In one embodiment, when a user instructs the handset 20 to send a binary message, the binary message module 80 determines whether the intended recipient is capable of receiving a binary message. If the recipient is capable, the binary message module 80 sends the binary message. If the recipient is only capable of receiving a part of the binary message, the binary message module 80 prompts the user for instructions on how to proceed and carries out those instructions, for example, send the message anyway, send only the text portion of the message, or cancel sending the entire message. In determining whether the intended recipient is capable of receiving a binary message, the binary message module 80 may consult the contact record for the intended recipient in cooperation with the contact management module 90 and also may initiate the sending of a binary message capability query to the intended recipient to initialize or update a contact record for the intended recipient, also in cooperation with the contact management module 90.

The binary message module 80 is also configured to respond to binary message capability queries. Accordingly, when the handset 20 receives a binary message capability query, the binary message module 80 compiles a response to the query identifying its capabilities for sending and receiving binary messages and sends the response to the requesting device. A response may be a global indicator (e.g., YES|NO) or it may be more granular and identify the specific types of binary objects that the handset 20 is capable of receiving.

In one embodiment, the contact management module 90 is configured to manage the list of contact records in the data storage area. The list of contact records may be separate from the phone book entries or the binary message capability information may be included with the phone book entries as a custom field or set of fields or otherwise integrated with the phone book. The contact management module 90 is configured to send binary message capability queries to intended recipients, delete records from the contact list that have timed out, and refresh binary message capability entries in a contact record.

For example, when a user instructs the handset 20 to send a binary message, the binary message module 80 may request a status of the intended recipient from the contact management module 90. If a contact record for the intended recipient is found in the data storage area, the capability for receiving binary messages is returned to the binary message module 80. If no record is available or if the information in the contact record is stale (e.g., according to the timestamp), the contact management module 90 constructs and sends a binary message capability query to the intended recipient. Upon receiving the response (or lack thereof), the contact management module 90 creates or updates the contact record for the intended recipient and then provides the capability information to the binary message module 80.

In one embodiment, the contact management module 90 may periodically purge contact records from the data storage area. Alternatively, the contact management module 90 may be configured to send a binary message capability query to all of the contact records in the phone book and update those records periodically to maintain an up to date list of the binary message capability for each contact in its phone book.

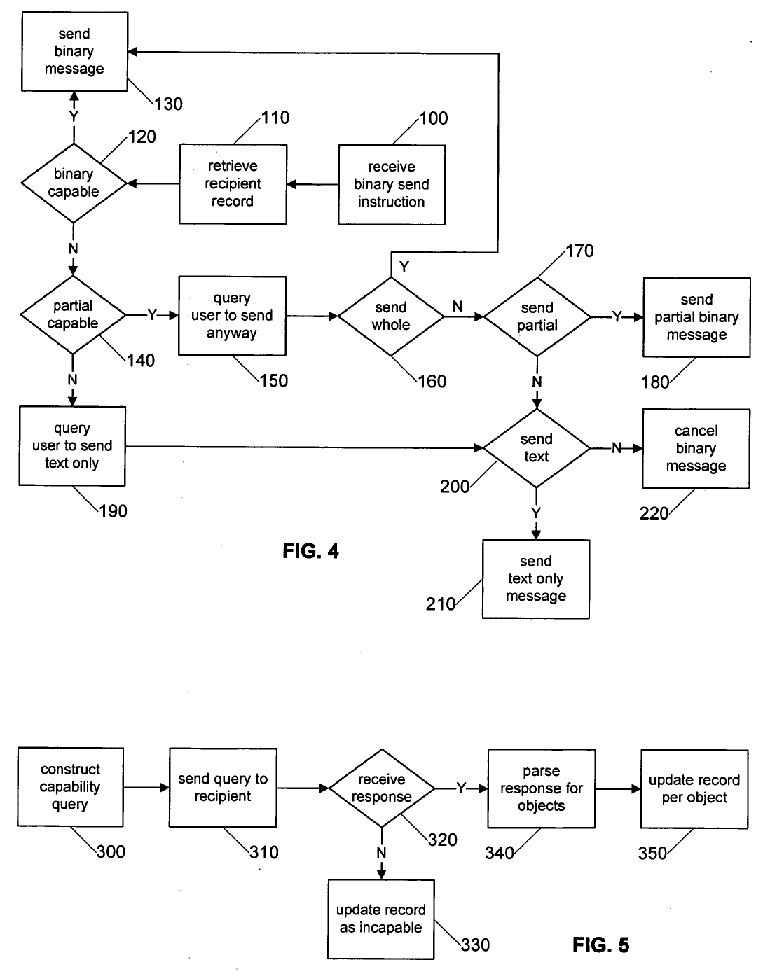

FIG. 4 is a flow diagram illustrating an example process for sending binary messages according to an embodiment of the present invention. The illustrated process can be carried out by the binary message module previously described with respect to FIG. 3 or may be carried out by both the binary message module and the contact management module, also described with respect to FIG. 3.

Initially, in step 100, the handset receives an instruction from the user to send a binary message. Next, in step 110 the handset retrieves the contact record for the intended recipient. The contact record may be separately maintained or may be part of the phone book record for the intended recipient. If the intended recipient is capable of receiving binary messages, as determined in step 120, the handset sends the binary message in step 130. If the recipient is not capable of receiving binary messages, the handset determines whether the recipient is capable of receiving a partial binary message.

In one embodiment, a partial binary message is a binary message with a particular type of binary object enclosed. For example, an MMS message with a binary contact enclosed could be a partial binary message. Also, an EHS or MMS message with a binary ringer tone enclosed could be a partial binary message. Additionally, it should be noted that a binary message may contain both text and binary content. For example, there may be introductory text with a binary object enclosed.

If the intended recipient is capable of receiving a partial binary message, a query is sent in step 150 to the user requesting instructions for how to proceed. The query may request that the user specify whether to send the entire binary message, as determined in step 160. For example, the recipient may be only partially binary message capable, but capable to receive the particular binary object that is being sent by the user. In such a case, the user may elect to send the whole binary message, which is then sent by the handset in step 130. In an alternative embodiment, the handset may automatically determine that the partially binary message capable recipient is able to receive the particular binary object in the binary message and then send the entire binary message to the recipient without intervention or further instruction from the user.

If the user elects not to send the whole binary message, as determined in step 160, the handset next determines in step 170 if the user desires to send a portion of the binary message. For example, the user may be sending a binary message including a ringer tone and a screen saver. If the recipient is capable of receiving the ringer tone but incapable of receiving the screen saver, the user may elect to only send the ringer tone binary object as part of the binary message. In such a case, the handset sends the partial binary message enclosing only the ringer tone, as illustrated in step 180.

If the user elects not to send a partial binary message, as determined in step 170, the handset determines in step 200 if the user wants to send a text only message. For example, a text only message may be an SMS message. Going back to step 140, if the handset determined that the recipient was not partially binary capable, in step 190 the handset queries the user to determine if the user wants to send a text only message. If the user does want to send a text only message, as determined in step 200, the handset sends the text only message in step 210. If the user does not want to send a text only message, as determined in step 200, the handset cancels the binary message.

FIG. 5 is a flow diagram illustrating an example process for determining the capability of a recipient device to receive a binary message according to an embodiment of the present invention. The illustrated process can be carried out by the contact management module previously described with respect to FIG. 3. For example, the contact management module may use this process to create or update a contact record for an intended recipient.

Initially, in step 300, the handset constructs a capability query. The capability query may be a simple SMS message with an embedded code. The embedded code may be a binary code or it may be a text code. The capability query may also be an altogether different type of communication and not an SMS message. Once the capability query is constructed, the handset sends the query to the recipient device in step 310. If the handset does not receive a response to the capability query, as determined in step 320, the handset creates a record for the recipient or updates an existing record for the recipient to indicate that the recipient is incapable of receiving a binary message, as shown in step 330. If the handset does receive a response to the capability query, as determined in step 320, the handset creates a record for the recipient or updates an existing record for the recipient to indicate that the recipient is capable of receiving a binary message.

In one embodiment, when the handset receives a response to the capability query, the handset parses the response in step 340 to determine what binary objects the recipient is capable of receiving. For example, the response to the capability query may provide list of binary objects that the recipient device is capable of receiving and processing. Alternatively, the response to the capability query may only provide a global indication of the recipient device's ability receive a binary message. In either case, in step 350 the handset creates a record for the recipient or updates an existing record for the recipient to indicate that the recipient is capable of receiving a binary message and also indicates the particular binary objects the device is capable of receiving if such information is provide in the response to the capability query.

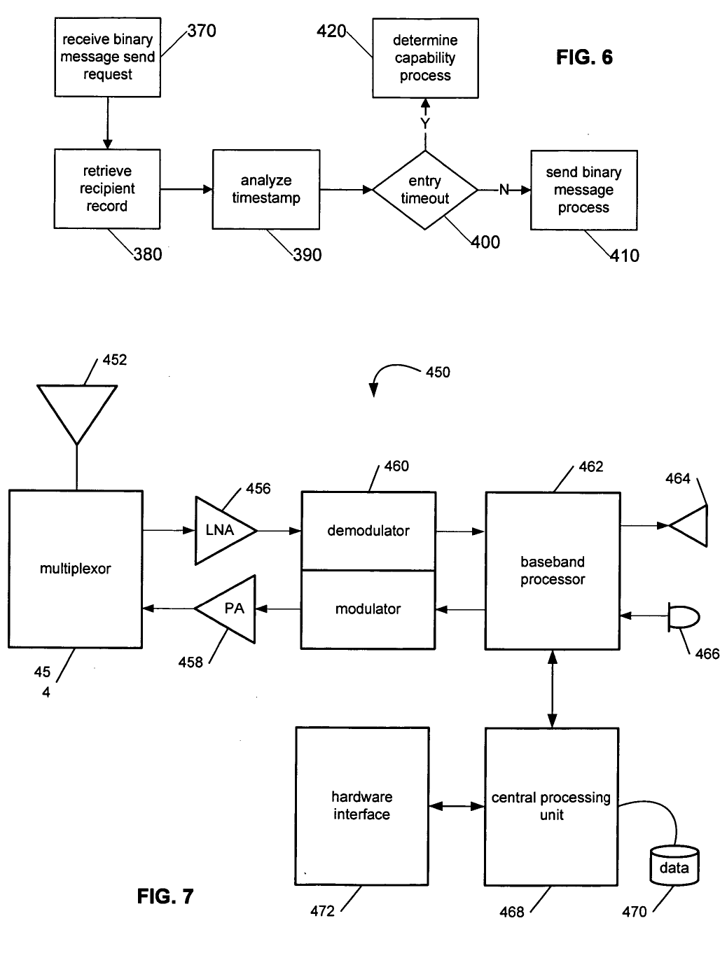

FIG. 6 is a flow diagram illustrating an example process for determining if a recipient entry has timed out according to an embodiment of the present invention. The illustrated process can be carried out by the contact management module previously described with respect to FIG. 3. For example, the contact management module may use this process to create or update a contact record for an intended recipient.

Initially, the handset receives a request to send a binary message to an intended recipient, as shown in step 370. Next, in step 380, the handset retrieves the record for the intended recipient from a data storage area. The record may be separately maintained by the handset or integrated with a phonebook entry for the particular intended recipient. After retrieving the record for the intended recipient, the handset analyzes the timestamp information in the record, as illustrated in step 390. If the timestamp indicates that the entry is stale, as determined in step 400, then the handset proceeds to determine the binary message capability of the intended recipient, as shown in step 420. In one embodiment, an expiration value may be set so that if the timestamp is older than the expiration value, the timestamp is determined to be stale. If the timestamp indicates that the entry is valid, as determined in step 400, then the handset proceeds to send a binary message to the intended recipient as illustrated in step 410.

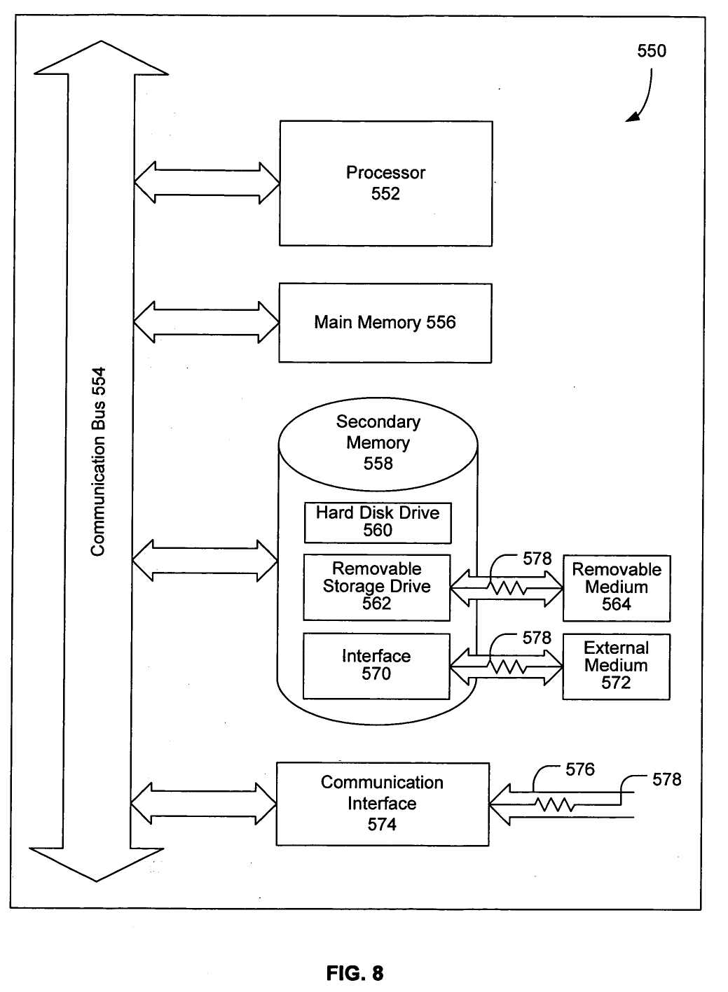

FIG. 7 is a block diagram illustrating an exemplary wireless communication device 450 that may be used in connection with the various embodiments described herein. For example, the wireless communication device 450 may be used in conjunction with a mobile handset as described above with respect to FIGS. 1 and 3. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

FIG. 8 is a block diagram illustrating an exemplary computer system 550 that may be used in connection with the various embodiments described herein. For example, the computer system 550 may be used in conjunction with an binary message server as described above with respect to FIG. 1. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A wireless communication device for sending a binary message, comprising:
a data storage area configured to store a plurality of contact records, wherein one or more contact records comprise an attribute indicating the ability for the respective contact to receive a binary message;
a contact management module configured to maintain the plurality of contact records and the respective binary message attribute;
a binary message module configured to communicate with the contact management module to determine the ability of an intended recipient to receive a binary message, the binary message module further configured to send a binary message to an intended recipient in response to an instruction to send a binary message to the intended recipient.

2. The wireless communication device of claim 1, wherein the binary message module is further configured to send a partial binary message in response to an instruction to send a binary message to the intended recipient.

3. The wireless communication device of claim 1, wherein a contact record comprises a timestamp attribute indicating the time when the contact record was created.

4. The wireless communication device of claim 3, wherein the contact management module is configured to discard a contact record when the timestamp attribute indicates that the age of the contact record exceeds a predetermined value.

5. The wireless communication device of claim 1, wherein a contact record comprises a timestamp attribute indicating the time when the contact record was last refreshed.

6. The wireless communication device of claim 5, wherein the contact management module is configured to discard a contact record when the timestamp attribute indicates that the last refresh of the contact record exceeds a predetermined value.

7. A computer implemented method for sending a binary message, comprising:
receiving an instruction to send a binary message;
retrieving a contact record for the intended recipient;
identifying a binary message capability attribute in the contact record;
analyzing the binary message capability attribute to determine if the intended recipient is capable of receiving a binary message; and
sending the binary message if the intended recipient is capable of receiving the binary message.

8. The method of claim 7, further comprising:
identifying one or more attributes in the contact record that indicate the ability of the intended recipient to receive a particular binary object if the intended recipient is not capable of receiving the binary message;
parsing the binary message to identify one or more binary objects that comprise the binary message; and
sending the one or more identified binary objects that comprise the binary message that the intended recipient is able to receive as indicated by the identified attributes in the contact record.

9. The method of claim 7, further comprising sending a text portion of the binary message if the intended recipient is not capable of receiving the binary message.

10. A computer implemented method for sending a binary message, comprising:
receiving an instruction to send a binary message;
identifying one or more binary objects that comprise the binary message;
retrieving a contact record for the intended recipient, the contact record stored in a data storage area;
parsing the contact record to identify one or more attributes that indicate the capability of the intended recipient to receive one or more binary objects that comprise a binary message;
analyzing the one or more attributes to determine if the intended recipient is capable of receiving the identified one or more binary objects that comprise the binary message; and
sending the binary message comprising the one or more binary objects that the intended recipient is capable of receiving.

11. The method of claim 10, wherein the parsing step further comprises:
parsing the contact record to identify a timestamp attribute indicating the time when the contact record was created; and
analyzing the timestamp attribute to determine if the age of the contact record exceeds a predetermined value.

12. The method of claim 10, wherein the parsing step further comprises:
parsing the contact record to identify a timestamp attribute indicating the time when the contact record was last refreshed; and
analyzing the timestamp attribute to determine if the last refresh time of the contact record exceeds a predetermined value.

13. A computer implemented method for sending a binary message, comprising:
receiving an instruction to send a binary message;
sending a binary capability query to the intended recipient;
receiving a response from the intended recipient, the response indicating the ability of the intended recipient to receive a binary message; and
sending the binary message if the intended recipient is able to receive the binary message.

14. The method of claim 13, further comprising:
creating a contact record for the intended recipient, the contact record comprising the ability of the intended recipient to receive a binary message; and
storing the contact record in a data storage area.

15. The method of claim 13, further comprising sending a portion of the binary message if the intended recipient is only able to receive a portion of the binary message.

16. The method of claim 15, wherein the portion of the binary message sent to the intended recipient comprises one or more binary objects.

17. The method of claim 16, wherein the portion of the binary message sent to the intended recipient comprises text.
